(19) United States
(12) Patent Application Publication
(10) Pub. No.: US 2018/0082071 A1
(43) Pub. Date: Mar. 22, 2018

(54) MULTI-TIERED ACCESS TO FUNCTIONALITY OF UNIVERSAL PLATFORM APPLICATIONS

(71) Applicant: Microsoft Technology Licensing, LLC, Redmond, WA (US)

(72) Inventor: David Tse, Redmond, WA (US)

(73) Assignee: Microsoft Technology Licensing, LLC, Redmond, WA (US)

(21) Appl. No.: 15/370,310

(22) Filed: Dec. 6, 2016

Related U.S. Application Data
(60) Provisional application No. 62/397,879, filed on Sep. 21, 2016.

(51) Int. Cl. G06F 21/62; G06F 21/31

(52) U.S. Cl. CPC G06F 21/629; G06F 2221/2113; G06F 21/31

(57) ABSTRACT

Technologies are provided for multi-tiered access to functionality and menus of a universal platform application by packaging the universal platform application with a desktop application of an executable. A universal platform application may be packaged with an executable that is launched automatically when the universal platform application is launched. Certain functionality, menus, or dialogs may be designated for elevated or restricted access permissions. Upon request to access one of those, the executable may be activated through predefined application programming interfaces (APIs) and check user credentials. If the user has the suitable credentials (e.g., administrator), the designated functionality, menus, or dialogs may be provided by the universal platform application.

### CROSS-REFERENCE TO RELATED APPLICATION

This Application claims priority under 35 U.S.C. § 119(e) to U.S. Provisional Patent Application Ser. No. 62/397,879 filed on Sep. 21, 2016. The disclosure of the U.S. Provisional Patent Application is hereby incorporated by reference in its entirety.

### BACKGROUND

While conventional applications with full access to libraries and other modules within an operating system framework are able to limit access to certain functionality based on user credentials such as regular user vs. administrator, modern applications packaged in application stores as “app” typically do not have multi-tiered functionality access. For example, universal platform applications that are packaged to be retrieved from an app store and installed as an “app” provide full access to all functionality and menus to the user.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling multi-tiered access to functionality and menus of a universal platform application by packaging the universal platform application with a desktop application of an executable. In some examples, a desktop application associated with a universal platform application (delivered in a single package and executed on the same computing device) may be notified by the universal platform application in response to receiving a request to access a specified functionality of the universal platform application. A credential check request may be received at the universal platform application from the associated desktop application and a user presented with a user interface to provide a credential. The provided credential may be provided by the universal platform application to the associated desktop application to determine a validity of the credential. Access to the specified functionality (and/or related menus and dialogs) may be provided in response to receiving an approval of the credential from the associated desktop application at the universal platform application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates conceptually a universal platform application and associated executable to provide multi-tiered access to the universal platform application, both provided as a package;

FIG. 2 illustrates conceptually a universal platform application and associated executable provided as a package and installed on a computing device to provide multi-tiered access to the universal platform application;

FIG. 3 and FIG. 4 illustrate conceptually actions in providing multi-tiered access to functionality of a universal platform application, arranged in accordance with at least some embodiments described herein;

FIG. 5 is a networked environment, where a system according to embodiments may be implemented;

FIG. 6 is a block diagram of an example general purpose computing device, which may be used to provide multi-tiered access to functionality of a universal platform application; and

FIG. 7 includes a logic flow diagram that illustrates a process to provide multi-tiered access to functionality of a universal platform application, according to at least some embodiments disclosed herein.

### DETAILED DESCRIPTION

As briefly described above, embodiments may be configured to provide multi-tiered access to functionality and menus of a universal platform application by packaging the universal platform application with a desktop application of an executable. A universal platform application may be packaged with an executable that is launched automatically when the universal platform application is launched. Certain functionality, menus, or dialogs may be designated for elevated or restricted access permissions. Upon request to access one of those, the executable may be activated through predefined application programming interfaces (APIs) and check user credentials. If the user has the suitable credentials (e.g., administrator), the designated functionality, menus, or dialogs may be provided by the universal platform application.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can, for example, be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing universal platform and/or desktop applications with different levels of functionality. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

The technical advantages of providing multi-tiered access to functionality and menus of a universal platform application by packaging the universal platform application with a desktop application of an executable may include, among others, improved performance, reduced processing, network bandwidth usage, energy savings, and improved user interaction by allowing administrators to access restricted functionality to address user issues on the same application without having to go through complex mechanisms.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with communications.

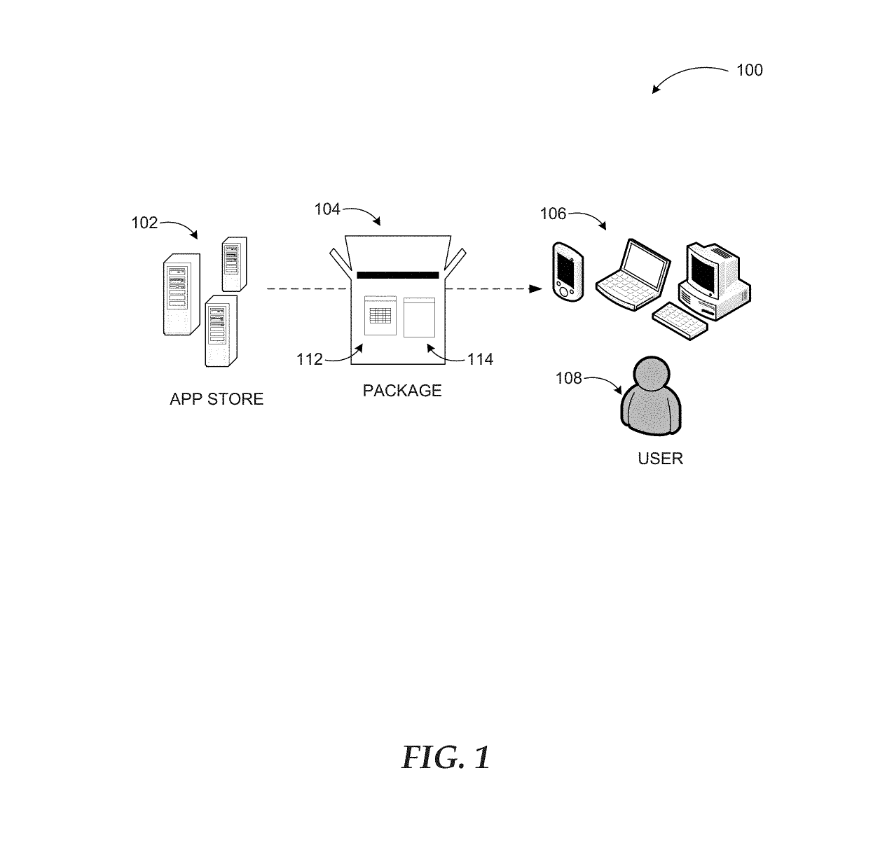

FIG. 1 illustrates conceptually a universal platform application and associated executable to provide multi-tiered access to the universal platform application, both provided as a package, according to at least some embodiments disclosed herein.

A universal platform application, as used herein, refers to an application that is part of a platform-homogeneous application architecture. Thus, a universal platform application may be executed on a number of operating systems, operating system versions, and/or devices without a need for customization or different versions of the application. For example, the same universal platform application may be installed/executed on a desktop platform and a mobile platform. Some universal platform applications may not indicate having been written for a specific operating system or platform in their manifest build; instead, they may target one or more device families, such as a PC, smartphone, tablet, or gaming systems. These extensions may allow the application to automatically utilize the capabilities that are available to the particular device it is currently running on. The platform-agnostic nature of these applications may allow enhanced user experience aspects in addition to efficiency and reduced complexity. For example, a universal platform application executed on a smartphone may start behaving the way it would if it were running on a PC when the smartphone is connected to a desktop computer or a suitable docking station. On the other hand, being platform agnostic may mean for some of these applications limitations over platform-specific applications. For example, a number and type of Application Programming Interfaces (APIs) available in the application may be limited. Thus, a functionality of a universal platform application may also be subject to constraints based on its design such as providing different levels of access based on user credentials.

Compared to universal platform applications, desktop applications, as referred to herein, are typically platform-specific such as operating system, operating system version, device, etc. While their specificity may make it more difficult to manage desktop applications on different devices or operating systems, it may also provide them with a higher degree of freedom with respect to functionality. Operating system or device specific APIs may be provided in desktop applications, for example. Thus, desktop applications may lend themselves more toward certain functionality. For example, functionality that is associated with monitoring and reacting to events that happen at operating system or hardware level. Following the example provided above, a desktop application may be configured to determine user credential based access level(s) to functionality and/or user interface menus and provide those.

In some scenarios, an application designer may want to provide different levels of access to application functionality and/or user interface for different types of users. Similarly, different types of users may want different levels of access. For example, an administrator may need access to configuration functionality, whereas a regular user may not necessarily need the same. In another example, a parent may want to restrict access to certain functionality of the application for their children such as accessing remote resources, downloading new features, and similar ones.

Universal platform applications are typically provided from an application store (“app store”) 102 and easily installed (e.g., self-installation). However, as described above, a universal platform application 112 alone may not be capable of providing multi-tiered access to functionality and user interface features. Thus, according to some embodiments, a universal platform application 112 may be provided from the app store 102 with an associated desktop application (or executable) 114 in an application package 104. A user 108 may receive the application package 104 from the app store 102 as they would with a regular universal platform application and have the universal platform application 112 and the desktop application 114 install on their computing device 106.

The computing device 106 may include a desktop computer, a laptop computer, a tablet computer, a smart phone, a vehicle mount computer, a wearable computer, or a special purpose computing device, among other devices. The computing device 106 may include a communication interface, a memory, and/or a processor, among other components, and may be configured to execute the universal platform application 112 and the desktop application 114.

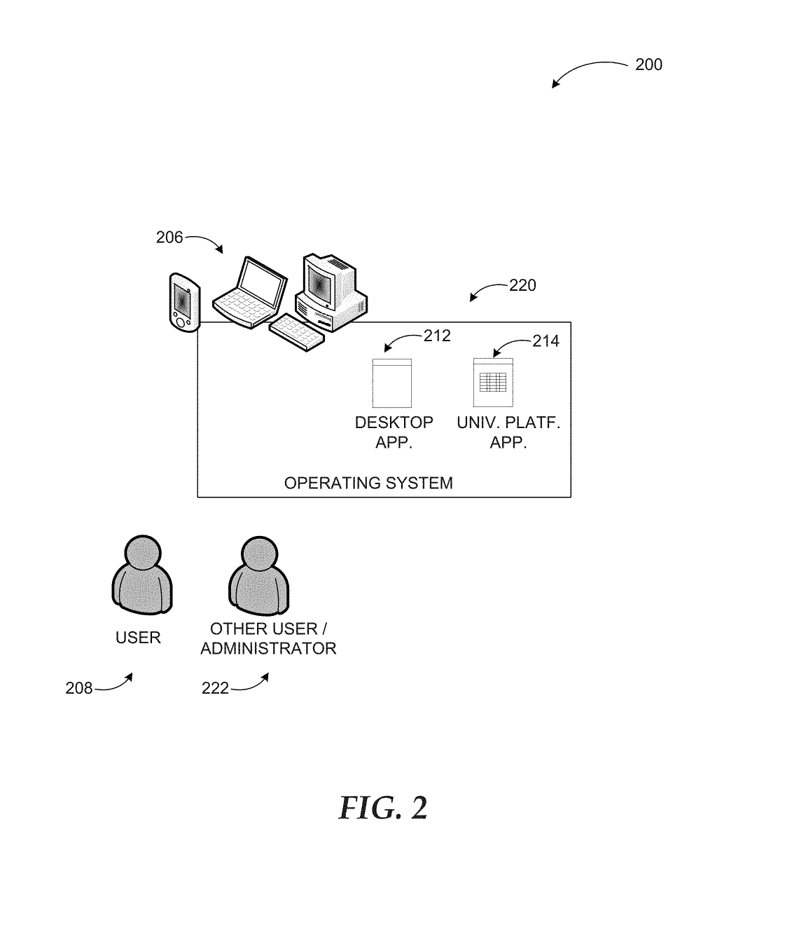

FIG. 2 illustrates conceptually a universal platform application and associated executable provided as a package and installed on a computing device to provide multi-tiered access to the universal platform application.

As mentioned previously, universal platform applications can be executed on any device and software platform, and are therefore subject to constraints of some of the platforms they are executed on. For example, a typical universal platform application may not be able to present multi-tiered functionality, menu, dialog.

Upon being received from an app store and being installed on a computing device 206, the universal platform application 212 and the desktop application 214 may be executed within the framework of operating system 220. The universal platform application 212 and the desktop application 214 may communicate through predefined APIs in providing multi-tiered access to universal platform application functionality, menus, and dialogs. For example, an administrator 222 may be provided access to menus and functionality restricted to a regular user 208.

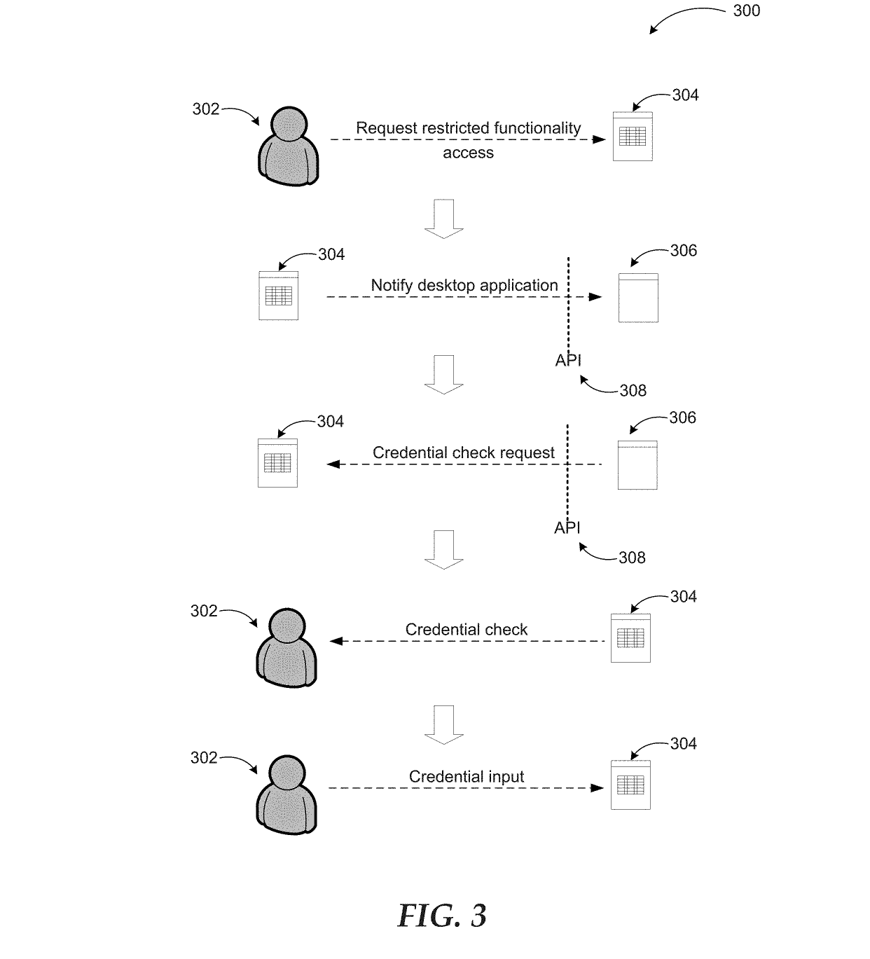

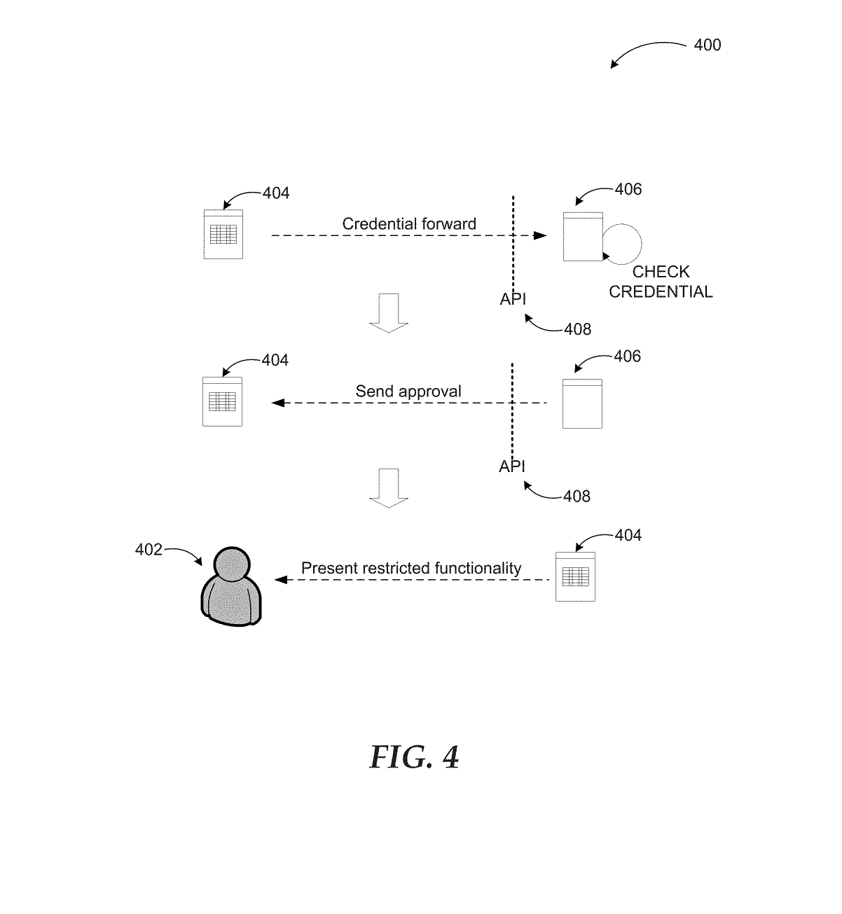

FIG. 3 and FIG. 4 illustrate conceptually actions in providing multi-tiered access to functionality of a universal platform application, arranged in accordance with at least some embodiments described herein.

Providing multi-tiered access to functionality of universal platform applications may begin with a user 302 requesting access to restricted functionality from a universal platform application 304 as shown in diagram 300. The universal platform application 304 may notify the associated desktop application 306 through a predefined API 308. In response, the desktop application 306 may send a credential check request to the universal platform application 304 via the API 308. Universal platform application 304 may include a number of APIs for specific purposes such as input device communication, handling images, handling various documents, tiled presentation, output device communication, and many more. In some examples, user profile or notification related APIs may be used to facilitate the communication between the universal platform application 304 and the desktop application 306.

The universal platform application 304 may present a user interface to the user 302 to input the required credentials. For example, the restricted functionality may be for administrators and the user 302 may enter the administrator credentials through the presented user interface by the universal platform application 304. Credentials may be input through textual entry (e.g., user name and password), biometric recognition (e.g., fingerprint, facial scan, or iris scan), voice recognition, or similar mechanisms.

As shown in diagram 400 of FIG. 4, the universal platform application 404 may provide the credentials received from the access requesting us (e.g., administrator) to the desktop application 406 via API 408. Upon receiving the credentials from the universal platform application 404, the desktop application 406 may check the credentials. If the credentials are approved, the desktop application 406 may send the approval to the universal platform application 404 via the API 408, which in turn may provide access to the requested functionality to the user 402. For example, the functionality may be account management menu for the universal platform application 404.

While the communication between the universal platform application and the desktop application are shown to be facilitated through the same API, in practice multiple APIs may be used for different communication exchanges such as user credential forwarding, notifications, etc.

The examples provided in FIG. 1 through FIG. 4 are illustrated with specific systems, services, applications, modules, and notifications. Embodiments are not limited to environments according to these examples. Embodiments to provide multi-tiered access to functionality of a universal platform application may be implemented in environments employing fewer or additional systems, services, applications, engines, modules, and notifications. Furthermore, the example systems, services, applications, engines, and modules shown in FIG. 1 through FIG. 4 may be implemented in a similar manner with other values using the principles described herein.

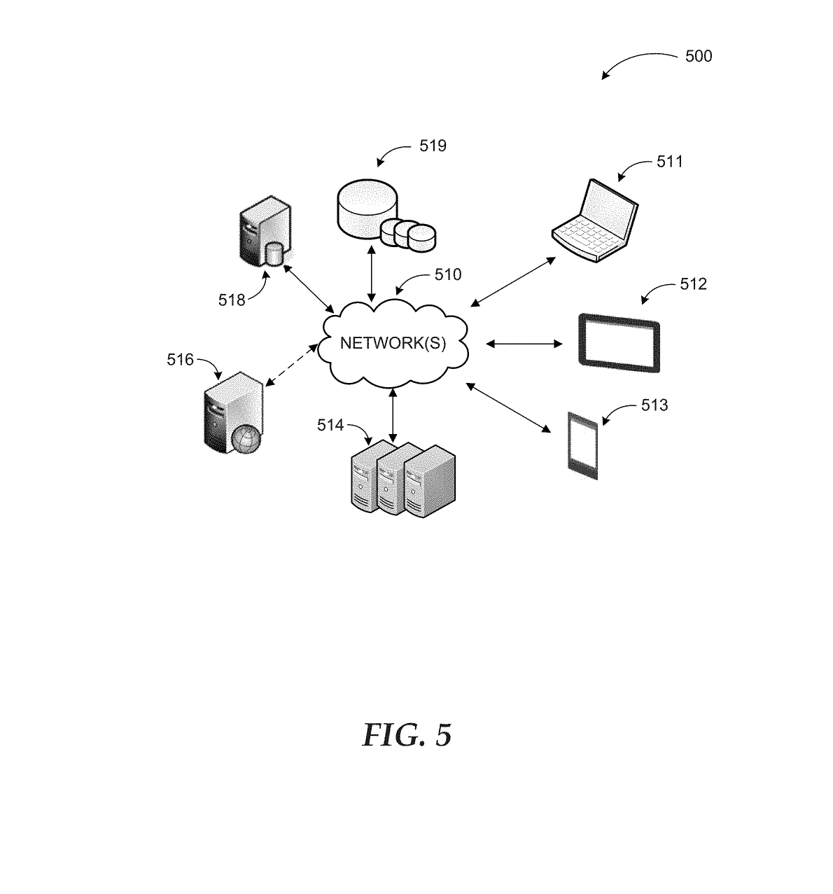

FIG. 5 is a networked environment, where a system according to embodiments may be implemented.

As shown in a diagram 500, a universal platform application with administrator elevation for select parts may be implemented in a networked environment over one or more networks, such as network 510. Users may access the service through locally installed or thin (e.g., browser) client applications executed on a variety of computing devices. Functionality within the service environment may be provided by a communication module or application executed within the service executed on servers 514 or processing servers 516.

A universal platform application, as discussed herein, may be implemented via software executed over servers 514. The servers 514, may include one or more processing servers 516, where at least one of the one or more processing servers 516 may be configured to execute one or more applications associated with the service. The service may store data associated with the application or user credentials in a data store 519 directly or through a database server 518.

The network 510 may comprise any topology of servers, clients, Internet service providers, and communication media. A system according to embodiments may have a static or dynamic topology. The network 510 may include multiple secure networks, such as an enterprise network, an unsecure network, or the Internet. The unsecure network may include a wireless open network. The network 510 may also coordinate communication over other networks, such as Public Switched Telephone Network (PSTN) or cellular networks. Furthermore, the network 510 may include multiple short-range wireless networks, such as Bluetooth, or similar ones. The network 510 may provide communication between the nodes described herein. By way of example, and not limitation, the network 510 may include wireless media. The wireless media may include, among others, acoustic media, RF media, infrared media, and other wireless media.

Many other configurations of computing devices, applications, engines, modules, data sources, and data distribution systems may be employed to provide a universal platform application with administrator elevation for select parts. Furthermore, the networked environments discussed in FIG. 5 are for illustration purposes only. Embodiments are not limited to the example applications, modules, engines, or processes.

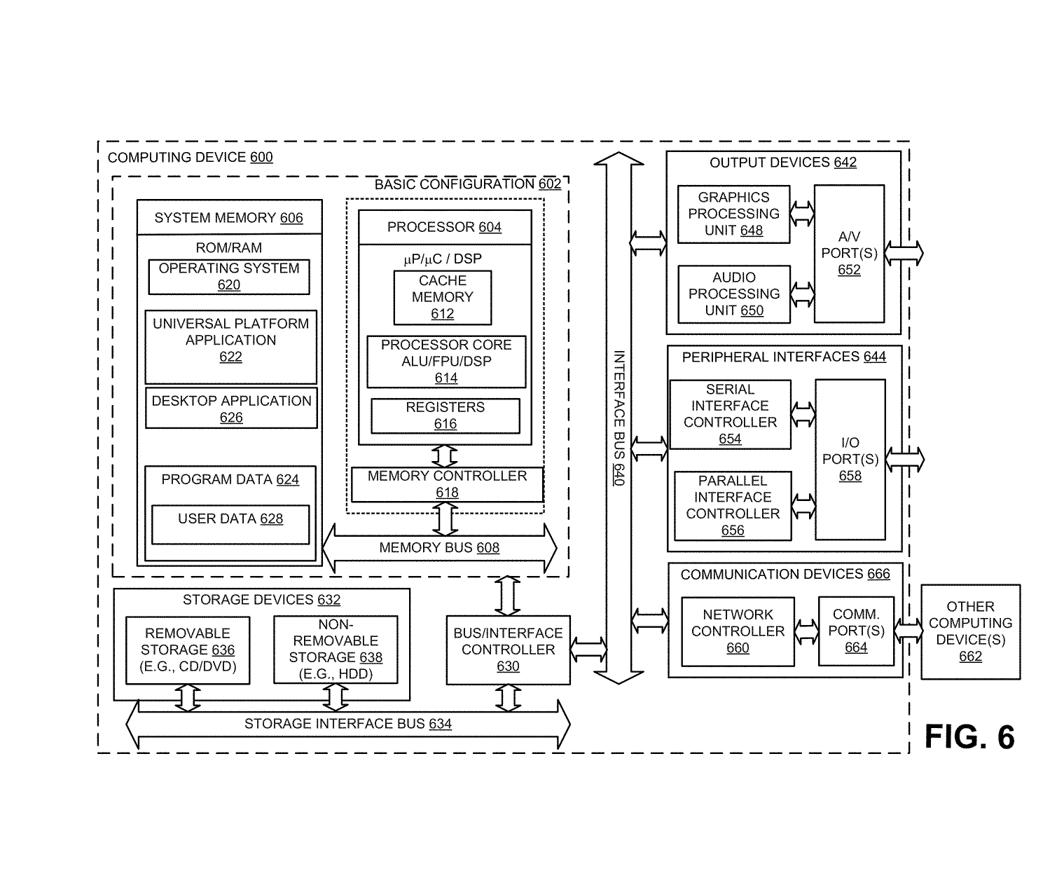

FIG. 6 is a block diagram of an example general purpose computing device, which may be used to provide a launch and keep-alive mechanism for universal platform applications, according to at least some embodiments described herein.

For example, a computing device 600 may be used as a server, a desktop computer, a portable computer, a smart phone, a special purpose computer, or a similar device. In an example basic configuration 602, the computing device 600 may include one or more processors 604 and a system memory 606. A memory bus 608 may be used for communicating between the processor 604 and the system memory 606. The example basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations the example memory controller 618 may be an internal part of the processor 604.

Depending on the desired configuration, the system memory 606 may be of any type including but not limited to volatile memory (such as RAM) and non-volatile memory (such as ROM, flash memory, etc.), or any combination thereof. The system memory 606 may include an operating system 620, a universal platform application 622, a desktop application 626, and program data 624. The universal platform application 622 may be packaged with the desktop application 626, a non-universal platform executable. The two applications together may provide multi-tiered access to parts of the universal platform application as described herein. Program data 624 may include, among others, user data 628.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store be desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and an example communication device 646) to the example basic configuration 602 via the bus/interface controller 630. Some of the one or more output devices 642 may include a graphics processing unit 648 and an audio processing unit 650, which may be configured to communicate with various external devices, such as a display or speakers via one or more A/V ports 652. The one or more peripheral interfaces 644 may include a serial interface controller 654 or a parallel interface controller 656, which may be configured to communicate with external devices, such as input devices (e.g., a keyboard, a mouse, a pen, a voice input device, and/or a touch input device, etc.) or other peripheral devices (e.g., a printer and/or a scanner, etc.) via one or more I/O ports 658. The example communication device 646 may include a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, the communication media may include wired media such as a wired network or direct-wired connection, and wireless media such as acoustic, radio frequency (RF), microwave, infrared (IR) and other wireless media. The term computer readable media, as used herein, may include both storage media and communication media.

The computing device 600 may be implemented as a part of a general purpose or a specialized server, a mainframe, or similar computer that includes any of the above functions. The computing device 600 may also be implemented as a personal computer, including both laptop computer configurations and non-laptop computer configurations.

Example embodiments may also include methods to provide a universal platform application with administrator elevation for select parts. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

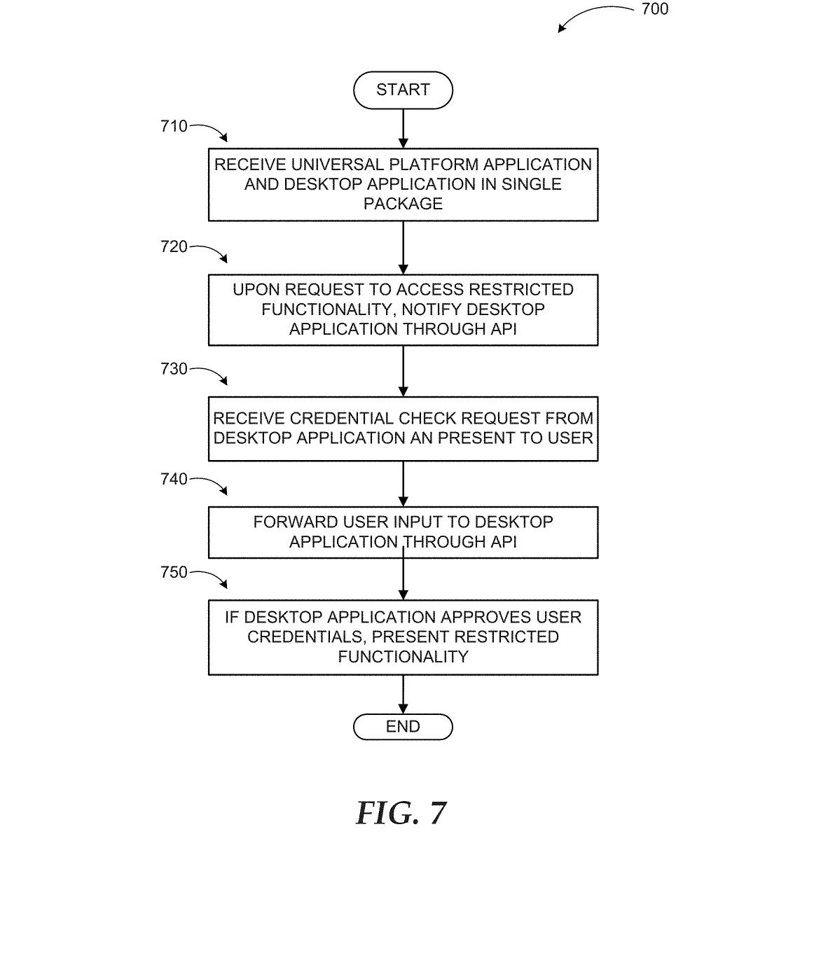

FIG. 7 includes a logic flow diagram that illustrates a process to provide multi-tiered access to functionality of a universal platform application, according to at least some embodiments disclosed herein.

Process 700 may be implemented on a computing device, server, or other system. An example computing device may include a communication interface, a memory, and a processor. The communication interface may be configured to facilitate an exchange of data with other computing devices. The memory may be configured to store instructions associated with a meeting management application. The processor may be coupled to the communication interface and the memory. The processor may be configured to receive and execute a universal platform application package that includes a universal platform application and an associated desktop application, to provide multi-tiered access to universal platform application functionality.

Process 700 may begin at operation 710, where the universal platform application and the accompanying desktop application (executable) may be received in a same package from an app store or similar source. Upon launch, the universal platform application may also launch the executable such that the executable monitors any requests for elevated functionality access. At operation the universal platform application may receive a request for a restricted or elevated functionality, menu, or dialog and notify the executable about the request through a predefined API.

At operation 730, the universal platform application may receive a request for credential check from the executable and present the user with the credential check request. For example, the restricted functionality may be reserved for administrators and the user may be prompted to input administrator credentials in order to access the requested functionality. Upon receiving the user input at operation 740, the universal platform application may forward the input to the executable.

Upon receiving a confirmation of the credentials from the executable at operation 750, the universal platform application may present the requested restricted functionality to the user. In some embodiments, the restriction may be binary (user vs. administrator). In other embodiments, the restriction may be multi-tiered for different permission levels.

The operations included in process 700 are for illustration purposes. Administrator elevation for parts of universal platform applications, according to embodiments, may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for providing multi-tiered access for parts of universal platform applications is described. The means may include in response to receiving a request to access a specified functionality of a universal platform application executed on a computing device, a means for notifying an associated desktop application executed on the same computing device; a means for receiving a credential check request from the associated desktop application; a means for presenting a user interface to provide a credential; forwarding the provided credential to the associated desktop application to determine a validity of the credential; and in response to receiving an approval of the credential from the associated desktop application, a means for providing access to the specified functionality.

According to some examples, a computing device to provide multi-tiered access for parts of universal platform applications is described. The computing device may include a communication interface configured to facilitate exchange of data with other computing devices; a memory configured to store instructions associated with a universal platform application and an associated desktop application; and a processor coupled to the communication interface and the memory. The processor may be configured to receive and execute a universal platform application package, where the universal platform application package includes the universal platform application and the associated desktop application. The universal platform application may be configured to in response to receiving a request to access a specified functionality, notify the associated desktop application; receive a credential check request from the associated desktop application; present a user interface to provide a credential; forward the provided credential to the associated desktop application; and in response to receiving an approval of the credential from the associated desktop application, provide access to the specified functionality. The associated desktop application may be configured to provide the credential check request to the universal platform application; determine a validity of the credential in response to receiving the credential from the universal platform application; and forward the approval of the credential to the universal platform application.

According to other examples, the specified functionality may include access to a subset of available functionality from the universal platform application. The subset of available functionality may include account management functionality associated with the universal platform application. The subset of available functionality may include configuration functionality associated with the universal platform application. The specified functionality may also include elevated access or restricted access to available functionality from the universal platform application, where the elevated access is reserved for an administrator.

According to further examples, the processor may be configured to receive the universal platform application and the associated desktop application in the universal application package from an app store. The universal platform application and the associated desktop application may be configured to self-install upon receipt of the universal application package by the processor. The universal platform application may be one or more of operating system agnostic, operating system version agnostic, and device agnostic. The associated desktop application may be one or more of operating system specific, operating system version specific, and device specific.

According to other examples, a method to provide multi-tiered access for parts of universal platform applications is described. The method may include in response to receiving a request to access a specified functionality of a universal platform application executed on a computing device, notifying an associated desktop application executed on the same computing device; receiving a credential check request from the associated desktop application; presenting a user interface to provide a credential; forwarding the provided credential to the associated desktop application to determine a validity of the credential; and in response to receiving an approval of the credential from the associated desktop application, providing access to the specified functionality.

According to some examples, the method may further include exchanging communications with the associated desktop application through one or more predefined application programming interfaces (APIs) at the universal platform application. The one or more APIs may include user profile related APIs. The one or more APIs may include notification related APIs. The method may also include receiving the credential through one or more of textual entry, biometric recognition, and voice recognition. Providing access to the specified functionality may include allowing access to a remote resource or allowing download of a feature for the universal platform application. Providing access to the specified functionality may further include one or more of displaying a restricted menu and displaying a restricted dialog.

According to further examples, a computer-readable memory device with instructions stored thereon for providing multi-tiered access for parts of universal platform applications is described. The instructions may include receiving a universal platform application package that includes a universal platform application and an associated desktop application; executing the universal platform application; in response to receiving a request to access a specified functionality of the universal platform application, notifying the associated desktop application through one or more predefined application programming interfaces (APIs) at the universal platform application; receiving a credential check request from the associated desktop application; presenting a user interface to provide a credential; forwarding the provided credential to the associated desktop application to determine a validity of the credential; and in response to receiving an approval of the credential from the associated desktop application, providing access to the specified functionality.

According to yet other examples, the associated desktop application may be specific to one or more of a computing device on which the universal platform application is executed, an operating system of the computing device, and an operating system version of the computing device. The instructions may also include providing one or elevated and restricted access to a subset of available functionality from the universal platform application along with a related menu and dialog.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide multi-tiered access for parts of universal platform applications, the computing device comprising:
a communication interface configured to facilitate exchange of data with other computing devices;
a memory configured to store instructions associated with a universal platform application and an associated desktop application; and
a processor coupled to the communication interface and the memory, the processor configured to receive and execute a universal platform application package, wherein the universal platform application package includes:
the universal platform application configured to:
in response to receiving a request to access a specified functionality, notify the associated desktop application;
receive a credential check request from the associated desktop application;
present a user interface to provide a credential;
forward the provided credential to the associated desktop application; and
in response to receiving an approval of the credential from the associated desktop application, provide access to the specified functionality; and
the associated desktop application configured to:
provide the credential check request to the universal platform application;
determine a validity of the credential in response to receiving the credential from the universal platform application; and
forward the approval of the credential to the universal platform application.

2. The computing device of claim 1, wherein the specified functionality includes access to a subset of available functionality from the universal platform application.

3. The computing device of claim 2, wherein the subset of available functionality includes account management functionality associated with the universal platform application.

4. The computing device of claim 2, wherein the subset of available functionality includes configuration functionality associated with the universal platform application.

5. The computing device of claim 1, wherein the specified functionality includes one of elevated access and restricted access to available functionality from the universal platform application.

6. The computing device of claim 5, wherein the elevated access is reserved for an administrator.

7. The computing device of claim 1, wherein the processor is configured to receive the universal platform application and the associated desktop application in the universal application package from an app store.

8. The computing device of claim 7, wherein the universal platform application and the associated desktop application are configured to self-install upon receipt of the universal application package by the processor.

9. The computing device of claim 1, wherein the universal platform application is one or more of operating system agnostic, operating system version agnostic, and device agnostic.

10. The computing device of claim 1, wherein the associated desktop application is one or more of operating system specific, operating system version specific, and device specific.

11. A method to provide multi-tiered access for parts of universal platform applications, the method comprising:
in response to receiving a request to access a specified functionality of a universal platform application executed on a computing device, notifying an associated desktop application executed on the same computing device;
receiving a credential check request from the associated desktop application;
presenting a user interface to provide a credential;
forwarding the provided credential to the associated desktop application to determine a validity of the credential; and
in response to receiving an approval of the credential from the associated desktop application, providing access to the specified functionality.

12. The method of claim 11, further comprising:
exchanging communications with the associated desktop application through one or more predefined application programming interfaces (APIs) at the universal platform application.

13. The method of claim 12, wherein the one or more APIs include user profile related APIs.

14. The method of claim 12, wherein the one or more APIs include notification related APIs.

15. The method of claim 11, further comprising:
receiving the credential through one or more of textual entry, bio recognition, and voice recognition.

16. The method of claim 11, wherein providing access to the specified functionality comprises:
allowing access to a remote resource or allowing download of a feature for the universal platform application.

17. The method of claim 11, wherein providing access to the specified functionality comprises one or more of:
displaying a restricted menu; and
displaying a restricted dialog.

18. A computer-readable memory device with instructions stored thereon for providing multi-tiered access for parts of universal platform applications, the instructions comprising:
receiving a universal platform application package that includes a universal platform application and an associated desktop application;
executing the universal platform application;
in response to receiving a request to access a specified functionality of the universal platform application, notifying the associated desktop application through one or more predefined application programming interfaces (APIs) at the universal platform application;
receiving a credential check request from the associated desktop application;
presenting a user interface to provide a credential;
forwarding the provided credential to the associated desktop application to determine a validity of the credential; and
in response to receiving an approval of the credential from the associated desktop application, providing access to the specified functionality.

19. The computer-readable memory device of claim 18, wherein the associated desktop application is specific to one or more of a computing device on which the universal platform application is executed, an operating system of the computing device, and an operating system version of the computing device.

20. The computer-readable memory device of claim 18, wherein the instructions further comprise:
providing one or elevated and restricted access to a subset of available functionality from the universal platform application along with a related menu and dialog.
